(19) United States
(12) Patent Application Publication
(10) Pub. No.: US 2020/0180603 A1
(43) Pub. Date: Jun. 11, 2020

(54) CHARGING CONTROL METHOD AND SYSTEM FOR BATTERY OF VEHICLE

(71) Applicants: Hyundai Motor Company, Seoul (KR); Kia Motors Corporation, Seoul (KR)

(72) Inventor: Jin Wook Kim, Anyang (KR)

(21) Appl. No.: 16/665,392

(22) Filed: Oct. 28, 2019

(30) Foreign Application Priority Data
Dec. 6, 2018 (KR) 10-2018-0155693

(51) Int. Cl. B60W 20/50; B60L 1/00; H02J 7/00

(52) U.S. Cl. CPC B60W 20/50; H02J 7/007; B60L 1/003

(57) ABSTRACT

A charging control method for a battery of a vehicle charges a high-voltage battery even when a current sensor fails in the eco-friendly vehicle. The method includes performing a fault diagnosis of a current sensor before starting to charge the battery in the vehicle and determining whether the current sensor has failed from the fault diagnosis result. Constant current (CC) charging control of charging the battery is then performed with a constant current in response to determining that the current sensor has failed.

### CROSS REFERENCE TO RELATED APPLICATION

The present application claims priority to Korean Patent Application No. 10-2018-0155693, filed Dec. 6, 2018, the entire contents of which is incorporated herein for all purposes by this reference.

### BACKGROUND

### Field of the Invention

The present invention relates to a charging control method and system for a battery of a vehicle and, more particularly to, a charging control method for a battery of a vehicle that is capable of normally charging a high-voltage battery even when an electric current sensor fails in an eco-friendly vehicle.

### Description of the Related Art

Eco-friendly vehicles are being developed due to environmental regulations. In particular eco-friendly vehicles include electric vehicles that are driven using a motor, such as a hybrid electric vehicle (HEV), a electric vehicle (EV), a fuel cell electric vehicle (FCEV), and the like. In addition, for the hybrid electric vehicle, a plug-in hybrid vehicle (PHEV) is known, and the plug-in hybrid electric vehicle (PHEV) and the electric vehicle (EV) have a common feature of plug-in electric vehicles in that they receive power battery from the outside to charge the battery.

In a plug-in electric vehicle, a battery operating as a driving source of a vehicle may be charged rapidly by connecting a direct current (DC) power source (e.g., rapid charging facility) directly to the battery or charged slowly by connecting an alternating current (AC) power source to the vehicle. A rapid charging facility used as the direct current (DC) power source in the rapid charging mode converts alternating current power into direct current power to be supplied to the vehicle and is directly connected to the vehicle battery to provide high current, whereby charging of the vehicle battery may be completed in a shorter period of time.

On the other hand, in the slow charging mode, when alternating current power is supplied to the vehicle using a commercial alternating current (AC) power source connected to the power distribution system, the alternating current power is converted into the direct current power in the vehicle to charge the battery. In the application of the slow charging mode, an on-board charger (OBC) having a circuit configuration of the power conversion system is mounted on the vehicle since the alternating current power supplied by the commercial alternating current power source must be converted into the direct current power in shape and size.

When the on-board charger is connected to the alternating current power source, the on-board charger converts the alternating current power into direct current power while converting the alternating current power into current and voltage suitable for charging a high-voltage battery to charge the high-voltage battery. In addition, the vehicle is equipped with a battery management system (BMS) that monitors and manages the state and operation of the battery. The battery management system collects battery status information using a sensor or a circuit while performing various controls for battery management such as charging discharging, and the like.

For example, the battery management system collects the battery status information such as voltage, current temperature, state of charge (SOC) of the battery and provides the collected battery status information to other controllers inside and outside the vehicle to be used for vehicle control and charging control. On the other hand, various technologies have been developed related to a charging device that charges the battery or a fault diagnosis device or circuit that diagnoses a fault in a battery-powered eco-friendly vehicle.

For example, a system of the related art discloses a battery state detection circuit, and a battery pack and a charging system having the same, which are capable of detecting a fault of a current detection unit and a temperature detection unit. In addition, another developed technology discloses a digital battery charging device having an automatic fault diagnosis function, a charge state diagnosis function, an equal charge function, a recovery charge function, and the like for the purpose of battery charging.

The developed technologies relate to a charging device or a fault diagnosis device (circuit), and the like, which discloses only a technology for diagnosing a fault but does not disclose a corresponding technology for enabling the battery to be charged when the fault is diagnosed or the fault occurs. In particular, in the related art, the battery status information of the battery management system, particularly the detection information of the current sensor, is used to control charging of the battery, and thus, the battery is unable to be charged when the current sensor fails.

### SUMMARY

The present invention provides a method for normally charging a high-voltage battery even when a current sensor fails in the eco-friendly vehicle.

According to an exemplary embodiment of the present invention, a charging control method for a battery of a vehicle may include performing a fault diagnosis of a current sensor before starting to charge the battery within a vehicle; by a controller, determining whether the current sensor has failed from the fault diagnosis result; and performing constant current (CC) charging control of charging the battery with a constant current when the controller determines that the current sensor has failed.

Herein, the vehicle may be driven by operating a motor with battery power, and the battery may be a main battery configured to supply operating power to the motor within the vehicle. In addition, the vehicle may be equipped with an on-board charger and may be a plug-in electric vehicle that receives power of the outside via the on-board charger to charge the battery, and the controller may be configured to operate the on-board charger to apply a constant current to the battery to charge the battery.

The charging control method for the battery of the vehicle according to an exemplary embodiment of the present invention may further include calculating a battery charging amount by summing a constant current value of a battery charging current as the constant current during the CC charging control and estimating a battery state of charge (SOC) using the calculated battery charging amount. In addition, the charging control method may include completing charging of the battery when the estimated battery SOC reaches a target SOC.

The charging of the battery may also be completed when a battery voltage reaches a target voltage. In addition, the charging control method may include performing constant power (CP) charging control of charging the battery with a constant power in response to determining that the current sensor is in a normal state.

The controller may be configured to determine a battery charging current during the CC charging control as the constant current based on a battery state immediately before the battery is charged. Herein, the controller may be configured to determine the battery charging current during the CC charging control based on a battery SOC or a battery voltage immediately before the battery is charged. In addition, the higher the battery SOC or the battery voltage immediately before the battery is charged, the lower the battery charging current is determined during the CC charging control.

The charging control method for the battery of the vehicle according to an embodiment of the present invention may further include outputting fault state information of the current sensor in response to determining that the current sensor has failed. According to a charging control method for a battery of a vehicle of the present invention, it may be possible to charge a battery using a CC charging method which is a charging method for a fault mode even when a current sensor fails.

In addition, according to a charging control method for a battery of a vehicle of the present invention, it may be possible to estimate the battery charging amount and battery SOC in real time by summing a constant current value to even when the current sensor fails, and it may be possible to perform the same functions as when the current sensor is in a normal state during charging, control, SOC estimation, and finishing charging of the battery, whereby the battery may be charged while ensuring stability and reliability related to the battery. In addition, according to a charging control method for a battery of a vehicle of the present invention, the battery may be charged with a constant current (CC) value that is optimized for vehicle and battery conditions.

### BRIEF DESCRIPTION OF THE DRAWINGS

The above and other objects, features and other advantages of the present invention will be more dearly understood from the following detailed description when taken in conjunction with the accompanying drawings, in which:

FIG. 1 is a block diagram showing a configuration of a system for charging a battery according to a charging control method of the present invention; and

FIG. 2 is a flowchart illustrating a charging control method according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context as used herein, the term “about” is understood as within a range of normal tolerance in the art, for example within 2 standard deviations of the men. “About” can be understood as within 10%, 9%, 8%, 7%, 6%, 5%, 4%, 3%, 2%, 10%, 0.5%, 0.1%, 0.05%, or 0.01% of the stated value. Unless otherwise clear from the context, all numerical values provided herein are modified by the term “about.”

Hereinafter, exemplary embodiments of the present invention will be described in detail with reference to the accompanying drawings so that those skilled in the art can easily cany out the present invention. However, the present invention is not limited to the exemplary embodiments described herein but may be embodied in other forms. Throughout the specification, when a certain part is referred to “having” an element, this means it can include other elements as well, rather than excluding other elements unless specifically stated otherwise.

The present invention relates to a charging control method for a battery of a vehicle and, more particularly to, a charging control method for a battery, which is capable of normally charging a battery even when an electric current sensor fails. Further, the present invention may be applied to a charging control method of a high-voltage battery (main battery) and may be applied to a battery charging control method that causes an eco-friendly vehicle to be driven by operating a motor with battery power.

As described above, a battery charging device or a fault diagnosis device was known in the related art, in which charging of the battery is impossible when a current sensor actually fails in a vehicle. However, the present invention provides a method for enabling charging of the battery, which may perform the same functions as when the current sensor is in a normal state during charging, control, SOC estimation, and finishing charging of the battery, whereby the battery may be charged while ensuring stability and reliability related to the battery.

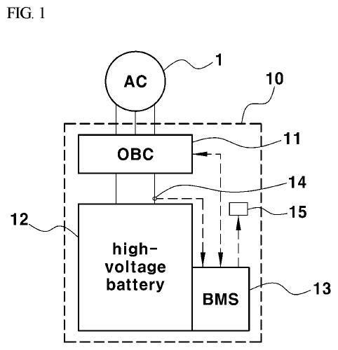

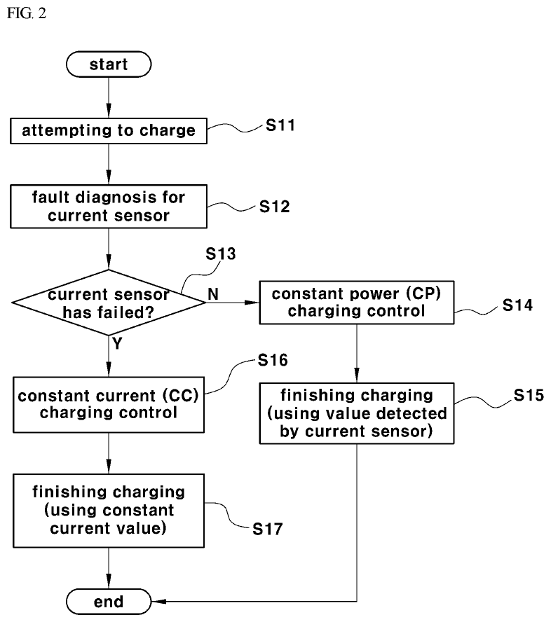

Hereinafter, a charging control method for a battery of a vehicle according to the present invention will be described in detail with reference to the drawings. FIG. 1 is a block diagram showing a configuration of a system for charging a battery according to a charge control method of the present invention; and FIG. 2 is a flowchart illustrating a charge control method according to an exemplary embodiment of the present invention.

Referring to FIG. 1, a configuration of a system is shown for charging a high-voltage battery 12 of a vehicle 10 using a slow charging mode, in which the vehicle is equipped with an on-board charger (OBC) 11, and the OBC 11 is connected to the high-voltage battery 12. The battery management system (hereinafter, referred to as ‘BMS’) 13 coupled to the battery 12 may be communicably connected to the OBC 11, and the OBC 11 may be connected to the power source outside the vehicle, that is, a commercial alternating current power source 1, to charge the battery 12 of the vehicle.

The BMS 13 may be configured to collect the battery status information using a sensor or a circuit not shown while performing various operations for battery management such as charging and discharging control. For example, the BMS 13 may be configured to collect the battery status information such as voltage, current temperature, and state of charge (hereinafter, referred to as ‘SOC’) of the battery 12 and provide the collected battery status information to other controllers inside and outside the vehicle to be used for vehicle control or charging control. In particular, the BMS 13 is a type of controller configured to execute a charging control process for the battery according to the present invention. The BMS 13 may be configured to select and switch battery charging modes according to the fault diagnosis result and execute a control process for charging the battery 12 according to the selected charging mode.

Referring to FIG. 2, when the OBC 11 of the vehicle 10 is connected to the commercial alternating current power source 1 and the driver attempts to charge the battery based on a typical battery charging start procedure (S11), the BMS 13 or a separate fault diagnosis device (not shown) may be configured to execute a fault diagnosis process for a current sensor 14 according to a determined logic before starting to charge the battery (S12).

In particular, the fault diagnosis process including the fault diagnosis logic for the current sensor 14 and the configuration of a hardware for performing the fault diagnosis are well known in the related art and thus will not be described in detail. When the BMS 13 is supposed to diagnose a fault in the current sensor 14 according to the fault diagnosis logic, the BMS 13 may be configured to determine whether the current sensor 14 fails based on the fault diagnosis logic.

However, when the fault diagnosis apparatus is provided separately, the fault diagnosis apparatus may configured to determine whether the current sensor 14 fails and transmit the determination result to the BMS 13. The failure of the current sensor 14 fails may be determined by performing the fault diagnosis process for the current sensor 14 (S13). When the controller, that is, the BMS 13, determines that the current sensor 14 is in a normal state in the step S13, the battery 12 may be charged and charging may be completed according to the normal charging control process and charging method (S14, S15).

Specifically, when the current sensor 14 is in a normal state, the BMS 13 may be configured to perform constant power (hereinafter, referred to as ‘CP’) charging control to cause the OBC 11 to output a constant power to the battery 12, whereby the CP charging may be performed for the battery 12 through the OBC 11 (S14). During CP charging of the battery 12, the actual charge amount and the battery SOC may be calculated and estimated respectively using the current value detected by the current sensor 14.

Herein, the charging may be completed when the estimated SOC reaches the target SOC or reaches the target voltage (S15). As described above, when the current sensor 14 is in a normal state, the battery 12 may be charged using the OBC 11 to perform CP charging, and thus, the battery voltage increases and the charging current decreases gradually as the charging is performed. For example, when the battery 12 is charged such that the battery SOC is higher from about 20% to 90%, the current is about 10.6 A based on about 3.3 kW when the starting voltage is about 310V, and the battery voltage is about 370V and the charging current is about 8.9 A based on about 3.3 kW when the battery 12 is gradually charged and thus the SOC is about 60%.

Additionally, when the battery 12 is further charged and thus the battery SOC becomes about 90%, the battery voltage becomes about 390V, and the current becomes about 8.4 A based on about 3.3 kW. The current sensor 14 configured to detect the current applied to the battery 12, that is, the charging current, may be used during CP charging of the battery, and the current value detected using the current sensor may be used to calculate and estimate a battery charging amount and the battery SOC.

Herein, the current value detected by the current sensor 14 may be added in real time (current(A)×times(hr.)) to calculate a total amount of current during the charging time, that is, the battery charging amount, and estimate the battery SOC using the calculated battery charging amount. The method of calculating and estimating the battery SOC from the battery charging amount is a well-known technology, and thus a detailed description thereof will be omitted.

In the related art, since the battery 12 is charged using the CP charging system, and the current value detected by the current sensor 14 must be used during CP charging, the battery is unable to be charged when the current sensor 14 fails. Therefore, a warning light of the cluster is turned on as an information providing device 15 to provide a notification to the driver regarding the fault of the current sensor 14. In particular, since it is impossible to charge the battery 12, the vehicle may be required to be towed, resulting in driver inconvenience.

When the current sensor 14 fails, it is impossible to charge the battery 12 in the related art, whereas in the present invention, in response to determining that the current sensor 14 fails, the battery 12 may be charged and charging may be completed using a separate charging control process and charging method capable of charging the battery 12 without using the current sensor 14 (S16, S17). In other words, when the current sensor 14 fails, the BMS 13 may be configured to perform a constant current (hereinafter, referred to as ‘CC’) charging control to cause the OBC 11 to apply a constant current to the battery 12, whereby the CC charging may be performed for the battery 12 using the OBC 11 (S16).

When the battery 12 is charged using the CC charging method, since a constant current is applied to the battery 12 the current may be summed to calculate the battery charging amount and thus the SOC may be estimated from the battery charging amount, even when the current sensor 14 fails. Accordingly, when the estimated SOC reaches a target SOC or reaches a target voltage, the charging may be completed (S17). As described above, according to the present invention, the battery 12 may be charged with a normal CP charging method when the current sensor 14 is in a normal state, whereas the battery 12 may be charged using the CC charging method which is the charging method for a fault mode when the current sensor 14 fails.

The CC charging method enables calculation and estimation of the battery charging amount and the SOC since the charging current value is known. In addition, since the BMS 13 is capable of detecting the battery SOC and the battery voltage immediately before the battery is charged, the charging current value may be adjusted based on the vehicle condition and the battery condition. For example, when the current sensor 14 fails in a low SOC state where the battery SOC is less than a first set value, then the charging current value may be set so that the BMS 13 may perform CC charging control of the battery 12 with a first charging current (e.g., about 10 A) via the OBC 11.

When the current sensor 14 fails in a middle SOC state where the battery SOC is equal to or greater than the first set value and less than a second set value, then the charging current value may be set so that the BMS 13 may perform CC charging control of the battery 12 with a second charging current (e.g., about 9 A) that is low compared to the low SOC state via the OBC 11. In addition, when the current sensor 14 fails in a high SOC state where the battery SOC is equal to or greater than the second set value, then the charging current value may be set so that the BMS 13 may perform CC charging control of the battery with a third charging current that is low compared to the middle SOC state via the OBC 11.

Accordingly, the charging current may be determined by the BMS 13 at the time of CC charging of the battery based on the SOC state immediately before the battery is charged, and herein, the higher the SOC immediately before the battery is charged, the lower the charging current the battery 12 is charged with, whereby the battery may be charged with a constant current (CC) value that is optimized for vehicle and battery conditions. In addition, the BMS 13 may be configured to determine the charging current at the time of CC charging of the battery as the battery status information, according to the battery voltage immediately before the battery is charged. Herein, the higher the battery voltage immediately before the battery is charged, the lower the charging current the battery 12 is charged with.

The actual charging current is about 10 A normally when charging a battery, and there is no problem in safety even when the actual battery is charged between about 20 A and 30 A. For example, when the battery is charged using the OBC 11, when the OBC output is normally a specification of about 3.3 kW, the battery voltage is between about 240 V and 410 V, whereby the current physically charging the battery does not exceed about 14 A and there is no problem even when the battery is charged with current of about 10 A. Of course, such numerical values are illustrative, and the present invention is not limited thereto, and the charging current may be changed through a preliminary principle test or a preceding test and evaluation for the object and the vehicle.

Since the current sensor 14 fails, it may be impossible for the BMS 13 to detect the battery charging current separately. Therefore, although the BMS 13 commands 10 A as the charging current, there may be a situation in which the battery is actually charged with the current higher than 10 A. However, even when the current sensor 14 fails, since the OBC 11 transmits the battery charging current via the CAN in the actual charging state, the BMS 13 may be configured to monitor the battery charging current to complete charging when the charging current is higher than the command value of the BMS 13.

Additionally, in the present invention, when the current sensor 14 fails, the BMS 13 may be configured to provide fault state information of the current sensor through the information providing device. In other words, a warning light of the duster may be turned on as the information providing device 15 to provide a notification to the driver regarding the fault state. However, the information providing device is not limited to a warning light and other known notification devices within the vehicle may be used. In the present invention, since the battery may be charged even when the driver detects the fault state of the current sensor 14, it may be possible to complete charging the battery normally and then move to the service center without additional towing.

Since the battery 12 may be charged with the constant current (CC) value so that the current value is known when the current sensor 14 fails, the current value may be added up in real time to calculate the battery charging amount (Ah) during the charging time, and the battery SOC may be estimated from the calculated battery charging amount. In addition, since the charging may be completed by determining whether the target value is reached based on the battery voltage or the battery SOC, the charging may be controllably completed without any problems even when the current sensor 14 fails. In the related art, since the charging of the battery is controlled using the current value detected by the current sensor, the battery is unable to be charged when the current sensor fails. However, in the present invention, it may be possible to charge the battery using the constant current (CC) charging method which is a charging method for fault mode even when the current sensor fails.

While the present invention has been particularly shown and described with reference to exemplary embodiments, it is to be understood that the invention is not limited to the disclosed exemplary embodiments, but, on the contrary, is included in the scope of the present invention.

What is claimed is:

1. A charging control method for a battery of a vehicle, comprising:
performing, by a controller, a fault diagnosis of a current sensor before starting to charge the battery of the vehicle;
determining, by the controller, whether the current sensor has failed from a fault diagnosis result; and
performing, by the controller, constant current (CC) charging control of charging the battery with a constant current in response to determining that the current sensor has failed.

2. The method of claim 1, wherein the vehicle is driven by operating a motor with battery power, and the battery is a main battery configured to supply operating power to the motor in the vehicle.

3. The method of claim 1, wherein the vehicle includes an on-board charger and is configured to receive outside power via the on-board charger to charge the battery, and the controller is configured to operate the on-board charger to apply a constant current to the battery to charge the battery.

4. The method of claim 1, further comprising:
calculating, by the controller, a battery charging amount by summing a constant current value of a battery charging current as the constant current during the CC charging control and estimating a battery state of charge (SOC) using the calculated battery charging amount.

5. The method of claim 4, further comprising:
completing, by the controller, charging the battery when the estimated battery SOC reaches a target SOC.

6. The method of claim 1, further comprising:
completing, by the controller, charging the battery when a battery voltage reaches a target voltage.

7. The method of claim 1, further comprising:
performing, by the controller, constant power (CP) charging control of charging the battery with a constant power in response to determining that the current sensor is in a normal state.

8. The method of claim 1, further comprising:
determining, by the controller, a battery charging current during the CC charging control as the constant current based on a battery state before the battery is charged.

9. The method of claim 8, further comprising:
determining, by the controller, the battery charging current during the CC charging control according to a battery state of charge (SOC) or a battery voltage before the battery is charged.

10. The method of claim 9, wherein the higher the battery SOC or the battery voltage before the battery is charged, the lower the battery charging current is determined during the CC charging control.

11. The method of claim 1, further comprising:
outputting, by the controller, fault state information of the current sensor via an information providing device in response to determining that the current sensor has failed.

12. A charging control system for a battery of a vehicle, comprising:
a memory configured to store program instructions; and
a processor configured to execute the program instructions, the program instructions when executed configured to:
perform a fault diagnosis of a current sensor before starting to charge the battery of the vehicle;
determine whether the current sensor has failed from a fault diagnosis result; and
perform constant current (CC) charging control of charging the battery with a constant current in response to determining that the current sensor has failed.

13. The system of claim 12, wherein the vehicle is driven by operating a motor with battery power, and the battery is a main battery configured to supply operating power to the motor in the vehicle.

14. The system of claim 12, wherein the vehicle includes an on-board charger and is configured to receive outside power via the on-board charger to charge the battery.

15. The system of claim 14, wherein the program instructions when executed are further configured to operate the on-board charger to apply a constant current to the battery to charge the battery.

16. The system of claim 12, wherein the program instructions when executed are further configured to:
calculate a battery charging amount by summing a constant current value of a battery charging current as the constant current during the CC charging control and estimating a battery state of charge (SOC) using the calculated battery charging amount.

17. The system of claim 16, wherein the program instructions when executed are further configured to:
complete charging the battery when the estimated battery SOC reaches a target SOC.

18. The system of claim 12, wherein the program instructions when executed are further configured to:
complete charging the battery when a battery voltage reaches a target voltage.

19. The system of claim 12, wherein the program instructions when executed are further configured to:
perform constant power (CP) charging control of charging the battery with a constant power in response to determining that the current sensor is in a normal state.

20. The system of claim 12, wherein the program instructions when executed are further configured to:
output fault state information of the current sensor via an information providing device in response to determining that the current sensor has failed.
